(19) United States
(12) Patent Application Publication
(10) Pub. No.: US 2020/0364420 A1
(43) Pub. Date: Nov. 19, 2020

(54) AUTONOMOUS RFID STORAGE SYSTEM

(71) Applicant: Storeroom Logix, LLC, Greensboro, NC (US)

(72) Inventors: Brad McCormick, Greensboro, NC (US); Andrea Mainiero, Greensboro, NC (US)

(73) Assignee: Storeroom Logix, LLC, Greensboro, NC (US)

(21) Appl. No.: 15/931,986

(22) Filed: May 14, 2020

Related U.S. Application Data
(60) Provisional application No. 62/849,732, filed on May 17, 2019.

(51) Int. Cl. G06K 7/10; G06Q 10/08; H04W 4/35; G07C 9/28; G07C 9/29

(52) U.S. Cl. CPC G06K 7/10099; G06Q 10/087; G07C 9/29; G07C 9/28; H04W 4/35

(57) ABSTRACT

An autonomous RFID storage system. The system includes a storage unit having a controlled access point and a RFID portal system at the controlled access point. The RFID portal system comprises a tower unit apart from the storage unit and positioned at a side adjacent to the controlled access point, a RFID sensor within the tower unit adapted to read a RFID tag, and a network connection system within the tower unit adapted to communicate with a management system. In one embodiment, the management system in communication with the network connection system is adapted to manage inventory within the storage unit by storing information for each item and updating information for each item based on an item identifier received from the network connection system.

### RELATED APPLICATION

The following application claims priority to U.S. Provisional Application No. 62/849,732 filed May 17, 2019, the disclosure of which is incorporated by reference in its entirety.

### BACKGROUND

### Field

The present inventions relate generally to storage systems and, more particularly, to an autonomous radio-frequency identification (RFID) storage system adapted to store and manage inventory within a storage unit.

### Related Art

As manufacturing facilities adopt lean management principles, they are relying more on their distributors to manage the inventory (referred to as vendor managed inventory or VMI). In many cases the end-users do not have time to keep all of their inventory organized, count inventory levels, reorder items and replenishment delivered inventory. The distributors will offer to provide their VMI services and be responsible for one, many or all of the aforementioned inventory tasks. Distributors will normally offer these services for free in exchange for the guarantee replenishment business. This arrangement is normally a win-win for both parties creating a long-lasting partnership and oftentimes opens the doors for new opportunities for cost savings and sales growth. VMI systems can be used in manufacturing plants, machine shops, OEM and panel builder facilities.

VMI systems are typically used to keep maintenance, repair, operational (MRO) and/or frequently used items organized and accessible for the end-users and can be found in manufacturing plants, machine shops, OEM and panel builder facilities. In addition, storage units can be located on the plant floor placed at or close to the point of use for convenient access or be placed in a central stores or crib area dedicated for inventory.

MRO inventory tends to be low cost, consumable items so purchasing departments will buy in bulk to prevent daily purchase orders for low cost items. Additionally the end-users of these items (maintenance/operational employees, panel builders, machine builders) expect to have enough of these items on hand so they can execute their daily tasks. In many cases, jobs or maintenance activities can be delayed due to item shortage limiting the company's production and profitability.

High dollar, critical spares and assets are normally not kept with these MRO items in fear of theft or misplacement. Due to the popularity and ease of use of online resell sites, companies are more conscious of the threat of pilferage and resell by their employees or outside contractors working in the facility. As a result these items are typically kept in a remote area of the plant in a storeroom or crib that is either locked or manned by an employee. Some end-users utilize carousel or helix style vending machines to secure inventory. While these offer security, only certain items fit into these machines. Many items are too big for either style machines while other items may be too small thus require pre-packaging which results in waste and extra work by the reseller or distributor.

Current VMI hardware is limited and does not provide an autonomous or semi-autonomous system for managing all inventory that can be very diverse in size, location, etc.

End-users typically do not have good clean usage data for their inventory and thus do not know how many of each item they should keep on hand. End-users also do not have an easy way to determine where inventory items are used in their plant or by department. Distributors also do not have a good way to offer this information as well as other important data such as their stocking levels, lead times, MTBF, etc. to the end-user at the point of purchase. End-users may make uneducated decisions about how many of an item they should keep on hand, so inventory is typically under or overstocked leading to downtime or dead inventory for the end-user.

The process of the traditional method is where a distributor user would go, perhaps once a day or once a week, to the area where the inventory is stored and audit each inventory bin. The user would rely on their tribal knowledge to decide if the inventory level of the item was low and then decide how many of that product to re-order. In many cases the user would hand write a list of the part numbers and the reorder quantity. In a conventional VMI model, this process is typically performed by a distributor salesperson or a driver who is frequently on-site at the account. However, in a VMI model, this person may change from week to week and the amount of tribal knowledge of the traditional method may not be consistent nor communicated between the different parties.

In both the traditional and VMI processes, once the reorder list is complete it is typically entered into an email and sent to the order entry department at the distributor site. In some cases, a handwritten list may be delivered to the order enterer. The order enterer would need to enter the part number and quantity into their business system. In some cases the part number, typically referred to SKU (stock keeping unit), may not have been written down correctly by the auditor causing extra time spent research the SKU. The order enterer would also have to look in their ERP system to see if this SKU was on backorder to prevent duplicating an order and cause overstock at the customer.

Once the order enterer enters the quote they would have to send it to the customer either via email or fax so the customer could make changes and generate a PO in their system for the material. In some cases the customer allows the distributor to put all VMI items on a blanket PO. If not, the customer would communicate back to the order enterer either via fax, email or phone and issue the distributor a PO for the material.

Industrial RFID solutions are bulky in construction and lack a sophisticated tracking system for determining whether a tagged product is coming in or leaving the storage unit. Many industrial RFID systems require a door with an access control system, a digital display, a computer and an access control system. This construction, due to the door or doorway frame, makes the RFID system very hard to place at entry/exit points of areas containing storage units. Many industrial facilities already have a pre-existing access control system in place at the entrance and exits of their storage area, so having an additional access control point from the RFID system becomes unnecessary. Many of these bulky RFID systems also rely on hardware, such as presence sensing mats, to determine if product is coming or leaving the storage area while other systems cannot track the delivery of material to the storage units and are only capable of tracking products being issued at the access control point. Thus, there remains a need for an improved storage system that is adapted to operate autonomously to store and to retrieve items while, at the same time, provides item information which may be used to manage inventory within one or more storage units.

### SUMMARY

The present inventions are directed to an autonomous RFID storage system including a storage unit having a controlled access point and a RFID portal system at the controlled access point. The RFID portal system comprises a tower unit apart from the storage unit and positioned at a side adjacent to the controlled access point, a RFID sensor within the tower unit adapted to read a RFID tag, and a network connection system within the tower unit adapted to communicate with a management system. A shielding may also be installed on the tower unit adapted to prevent inadvertent reads of RFID tags by the RFID sensor.

In one embodiment, the autonomous RFID storage system further includes a RFID tag assigned to an item. The RFID tag assigned to the item may be associated with an item identifier for that item. For example, the item identifier may be an electronic product code, a stock keeping unit, a RFID serial number, a user identification, a timestamp or combinations thereof.

In one embodiment, the RFID portal system further includes a user authentication system for identifying individuals accessing the storage unit at the controlled access point.

For example, the user authentication system may comprise a key fob system. In addition, the RFID portal system may also include a security camera system adapted to provide a visual signal. A network camera system may be included to store the visual signals obtained from the security camera system and assign those visual signals to a RFID transaction. The visual signal may comprise an image selected from a video feed.

The RFID portal system may include a portable hub device adapted to be carried by a user for determining whether an item is being checked in, issued or returned by assigning a status for the item. One example of a portable hub device may be a smartphone. In one embodiment, the portable hub device is adapted to assign an item identifier to a RFID tag.

The portable hub device may assign the status of an item to a status database, wherein the status database may be adapted to compare the status of the item with the item identifier received from the network connection system. Possible statuses that may be assigned to an item include an assigned status, a delivery manifest status, a check-in status, an available status, an issued status, a return manifest status, or a returned status. The network connection system may be a wireless network connection system in communication with a cloud storage system.

The autonomous RFID storage system may further include a management system in communication with the network connection system adapted to manage inventory within the storage unit by storing information for each item and updating information for each item based on the item identifier received from the network connection system. In one embodiment, the management system manages inventory for a plurality of storage systems. The plurality of storage systems may be on-site.

The autonomous RFID storage system may further include a dynamic on-hand inventory system adapted to calculate an on-hand inventory quantity of an item. The dynamic on-hand inventory system may calculate the on-hand inventory quantity of an item on an interval based on a plurality of variables. For example, the plurality of variables may include an item usage history, an item stock from a vendor, a product criticality to a customer, a lead time, an average time until failure for the item, an average number of delivery days, or combinations thereof. The dynamic on-hand inventory system may be adapted to calculate the reorder quantity when a counter indicates a quantity of an item is below the on-hand inventory quantity. The interval may be one month.

In addition, the dynamic on-hand inventory system may be adapted to retrieve and manage data from a plurality of vendors. In one embodiment, the dynamic on-hand inventory system is integrated with a vendor system for sending and retrieving data via an application programming interface, a file transfer protocol, an electronic data interchange, and combinations thereof.

Accordingly, one aspect of the present inventions is to provide an autonomous RFID storage system including (a) a storage unit having a controlled access point; (b) a RFID portal system at the controlled access point, the RFID portal system having (i) a tower unit apart from the storage unit and positioned at a side adjacent to the controlled access point; (ii) a RFID sensor within the tower unit adapted to read a RFID tag; and (iii) a network connection system within the tower unit adapted to communicate with a management system.

Another aspect of the present inventions is to provide a RFID portal system for an autonomous RFID storage system having a storage unit with a controlled access point, the RFID portal system comprising: (a) a tower unit apart from the storage unit and positioned at a side adjacent to the controlled access point; (b) a RFID sensor within the tower unit adapted to read a RFID tag; (c) a network connection system within the tower unit adapted to communicate with a management system; and (d) a portable hub device adapted to be carried by a user for determining whether an item is being checked in, issued or returned by assigning a status for the item.

Still another aspect of the present inventions is to provide an autonomous RFID storage system comprising: (a) a storage unit having a controlled access point; (b) a RFID tag assigned to an item and having an item identifier associated for the item; (c) a RFID portal system at said controlled access point, the RFID portal system having (i) a tower unit apart from the storage unit and positioned at a side adjacent to the controlled access point; (ii) a RFID sensor within the tower unit adapted to read the RFID tag; (iii) a network connection system within the tower unit adapted to communicate with a management system; (iv) a portable hub device adapted to be carried by a user for determining whether the item is being checked in, issued or returned by assigning a status for the item; and (d) a management system in communication with the network connection system adapted to manage inventory within a storage unit by storing information for each item and updating information for each item based on an item identifier received from the network connection system.

These and other aspects of the present inventions will become apparent to those skilled in the art after a reading of the following description of the embodiments when considered with the drawings.

### BRIEF DESCRIPTION OF THE DRAWINGS

FIG. 1A is a front perspective view of an inventory area with a controlled access point and an autonomous RFID storage system installed at the controlled access point according to one embodiment of the present inventions;

FIG. 1B is a front perspective view of a tower unit for a RFID portal system adjacent to a controlled access point;

FIG. 2 is a front perspective view of a tower unit for a RFID portal system according to one embodiment;

FIG. 3A is a rear perspective view of the tower unit shown in FIG. 2 partially disassembled;

FIG. 3B is a front perspective view of the tower unit shown in FIG. 2 partially disassembled;

FIG. 4 is a perspective view of a portable hub device according to one embodiment;

FIG. 5 is a flowchart of statuses that may be assigned to an item according to one embodiment;

FIG. 6 is a flowchart showing how the status of an item may be determined and/or changed by a RFID portal system when a RFID tag is read by a RFID sensor according to one embodiment;

FIG. 7 is a flowchart of a RFID tag assigned to an item according to one embodiment;

FIG. 8 is a flowchart of a RFID portal system communicating with a management system when a RFID tag is read and the status of the item is issued according to one embodiment;

FIG. 9 is a flowchart on assigning user tags according to one embodiment;

FIG. 10 is a flowchart of a RFID storage system in communication with multiple vendors according to one embodiment;

FIG. 11 is a flowchart of a RFID storage system with a security camera system according to one embodiment; and

FIG. 12 is a flowchart of a RFID storage system in connection with a status database and data hub of a management system according to one embodiment.

### DETAILED DESCRIPTION OF THE EMBODIMENTS

In the following description, like reference characters designate like or corresponding parts throughout the several views. Also in the following description, it is to be understood that such terms as “forward,” “rearward,” “left,” “right,” “upwardly,” “downwardly,” and the like are words of convenience and are not to be construed as limiting terms.

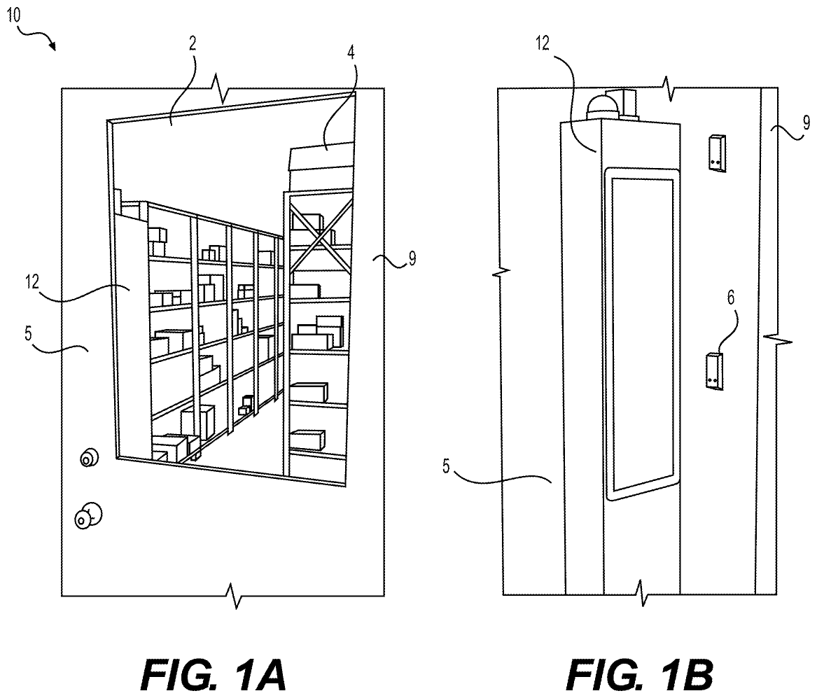

Referring now to the drawings in general and FIG. 1 in particular, it will be understood that the illustrations are for the purpose of describing an embodiment of the inventions and are not intended to limit the inventions thereto. As best seen in FIGS. 1A and 1B, an automated RFID storage system, generally designated as 10, includes a storage unit 2 adapted to store one or more items 4. The storage unit includes a controlled access point 6 for limiting access to the items 4 to authorized individuals. Adjacent to the controlled access point 6 is a separate RFID portal system 12. The RFID portal system 12 is a separate unit positioned at a side 5 of the controlled access point 6, and may be positioned behind or in front of a door 9 having a controlled access point 6 (FIGS. 1A and 1B, respectively). As will be later described, the RFID portal system 12 may be adapted to assign a status for each item 6 entering and exiting the storage unit 2.

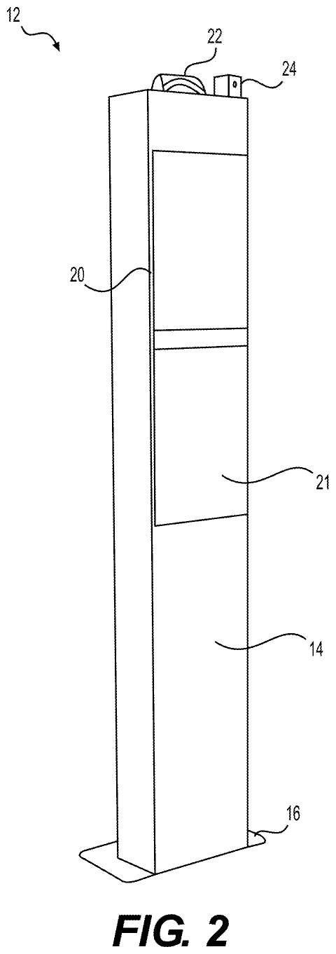

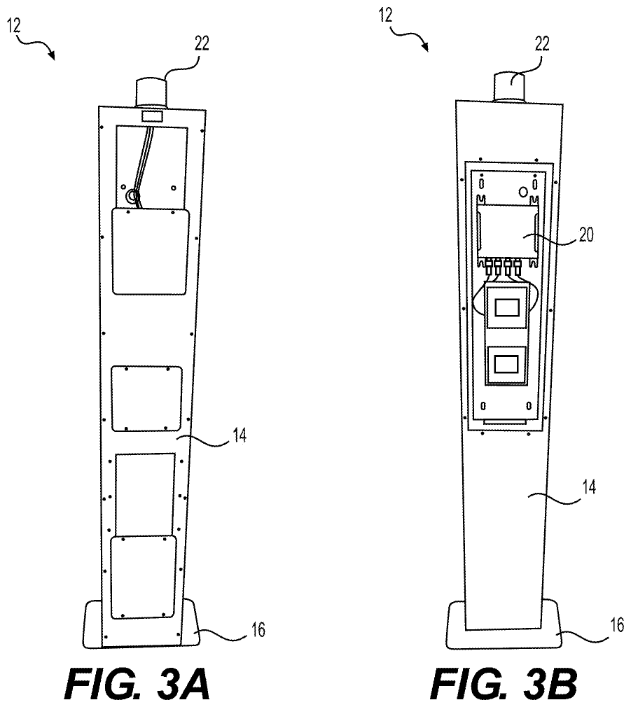

As shown in FIGS. 2, 3A and 3B, the RFID portal system 12 may comprise a tower unit 14 having a vertical chassis with a base 16. The tower unit is separate from the controlled access point 6 and not integrated into the storage unit 2, and therefore the tower unit 14 is compatible with and adapted for use with any storage unit that may be manufactured by third-parties.

A RFID sensor 20 for reading RFID tags affixed to items is housed within the tower unit 14. A shielding 21 may be installed on the tower unit 14 to prevent inadvertent reads from the RFID sensor 20. The tower unit 14 also includes a network communication system 22 for communicating with a management system 50. The RFID portal system may also include a user authentication system for identifying individuals accessing the storage unit. For example, the user authentication system may comprise a key fob system. The key fob may be read by the RFID sensor 20. Other possible access control sensors may include fingerprint and retinal scanners as well as facial recognition.

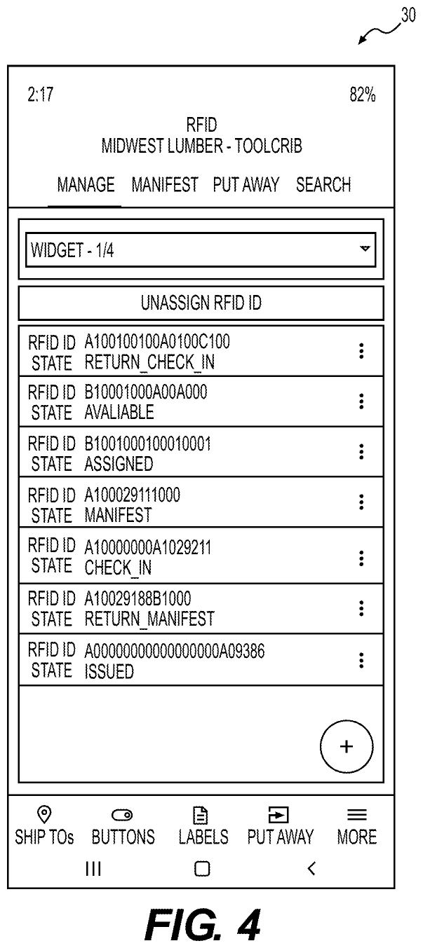

Turning to FIG. 4, the RFID portal system 12 may include a hub adapted to manage one or more storage units 2. For example, the hub may be adapted to manage between about one and about ten storage units 2. The plurality of storage units may be installed adjacent to one another or located away from each other and the hub. The hub is also adapted to determine whether an item is being checked in, issued or returned. In one embodiment, the hub may be a portable hub device 30. The portable hub device 30 is adapted to be carried by a user, and in one example, the portable hub device 30 is a smartphone. Other examples may include a tablet or other handheld computing device. The user may utilize the portable hub device 30 to assign a status for an item, and the status of an item may be communicated to a management system.

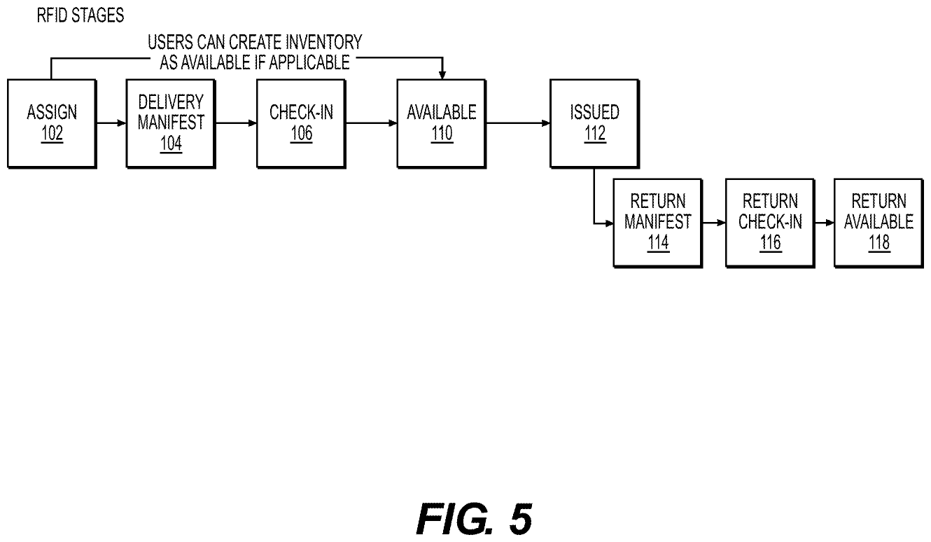

FIG. 5 provides a general overview of the various statuses that may be assigned to an item according to one embodiment. During warehouse picking and packing of material that is on order, a RFID tag and corresponding item identifier may be assigned to an item, and the status of the item is designated as “assign” 102. While an item is in the assign stage 102, an association may be created between the item identifier and a vendor's SKU. One example of an item identifier may be an electronic product code. No change occurs if the RFID tag is read by the RFID sensor 20 during the assign stage 102.

As an item 4 is being delivered to a storage unit 2, the item's status may be designated as delivery manifest 104. In the delivery manifest stage 104, the portable hub device 30 may be used to scan or read the item identifier of the RFID tag. The item identifier may be printed or encoded on the RFID tag. The portable hub device 30 may include the capability to list including multiple items to be delivered. Once the item identifier(s) are submitted, the RFID sensor 20 can read the RFID tag and modify the item's status to check-in 106 to designate that the item 4 has been delivered.

At the check-in stage 106, the item is delivered within the storage unit 2. A user may use the portable hub device 30 to determine where the delivered item is to be placed within the storage unit; for example, by scanning or reading the item identifier. No change in status will occur if the RFID tag is read by the RFID sensor 20 during the check-in stage 106. Once the item is placed in the proper place within the storage unit, the user may modify the status of the item to available 110. Alternatively, the user may also have an item's status automatically designated to available 110. For example, the item's status may change to available 110 after a designated amount of time has elapsed or at a certain time of day.

Once an item 4 becomes available 110, then the item is in the storage unit's inventory. The portable hub device 30 may enable a user to automatically count items within a storage unit's inventory that are available 110 or in a return stage. If the RFID tag is read by the RFID sensor 20 after the item 4 is assigned as available 110, then the status of the item is changed to issued 112. After an item's status is changed to issued 112, the item is no longer considered part of the storage unit's inventory and will not be counted as such by the portable hub device 30.

After an item 4 is issued 112, the portable hub device 30 may also capture user information. For example, the user may receive an email or alert on the portable hub device 30 to enter data for various fields, such as a work order number or what machine the item may be used on. No change occurs if the RFID tag is read by the RFID sensor 20 while an item is designated as issued 112.

If a user desires to return an item 4, the item may enter a return manifest stage 114. During the return manifest stage 114, the portable hub device 30 may be used to scan or read the item identifier of the RFID tag. The portable hub device 30 may include the capability to list including multiple items to be returned. Once the item identifier(s) are submitted, the RFID sensor 20 can read the RFID tag and modify the item's status to return check-in 116 to designate that the item 4 has been returned.

At the return check-in stage 116, the item is returned within the storage unit 2. A user may use the portable hub device 30 to determine where the returned item is to be placed within the storage unit; for example, by scanning or reading the item identifier. No change in status will occur if the RFID tag is read by the RFID sensor 20 during the return check-in stage 116. Once the item is placed in the proper place within the storage unit, the user may modify the status of the item to return available 118. Alternatively, the user may also have an item's status automatically designated to return available 118. For example, the item's status may change to return available 118 after a designated amount of time has elapsed or at a certain time of day. Once an item 4 becomes return available 118, then the item is in the storage unit's inventory.

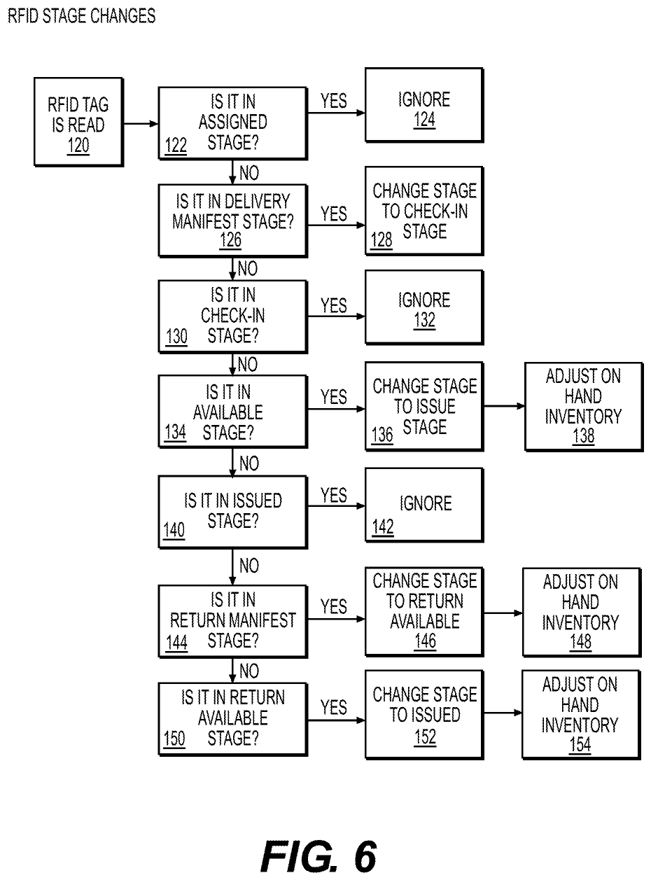

FIG. 6 is a flowchart providing an example of how the status of an item may be determined and/or changed by a RFID portal system when a RFID tag is read by a RFID sensor 120. The RFID portal system ascertains whether the status of the item associated with the RFID tag is in the assigned stage 122. If the item is in the assigned stage 122, then the read of the RFID tag is ignored and no change in item status occurs 124. If the item is not in the assigned stage, then the RFID portal system checks whether the status of the item is in the delivery manifest stage 126. If the item is in the delivery manifest stage 126, then the item's status is changed to check-in 128. If the item is not in the delivery manifest stage 126, then the RFID portal system checks to see whether the status of the item is in the check-in stage 130. If the item is in the check-in stage, then the read of the RFID tag is ignored and no change in item status occurs 132. If the item is not in the check-in stage 130, then the RFID portal system determines if the item is available 134. If the item is available, then the status of the item is changed to issued 136 and the on-hand inventory is adjusted accordingly 138. If the item is not available, the RFID portal system determines whether the item is issued 140. If the item is issued, then the read of the RFID tag is ignored and no change in item status occurs 142. If the item is not issued, then the RFID portal system ascertains whether the item is in the return manifest stage 144. If the item is in the return manifest stage, then its status is changed to either return check-in or return available 146 depending on a user's settings. Once the item is changed to return available 166, then the on-hand inventory is adjusted 148 to account for the item. If the item is not in the return manifest stage, the RFID portal system checks whether the item is in the return available stage 150. If the item is in the return available stage, the status of the item is changed to issued and the on-hand inventory is adjusted accordingly 134.

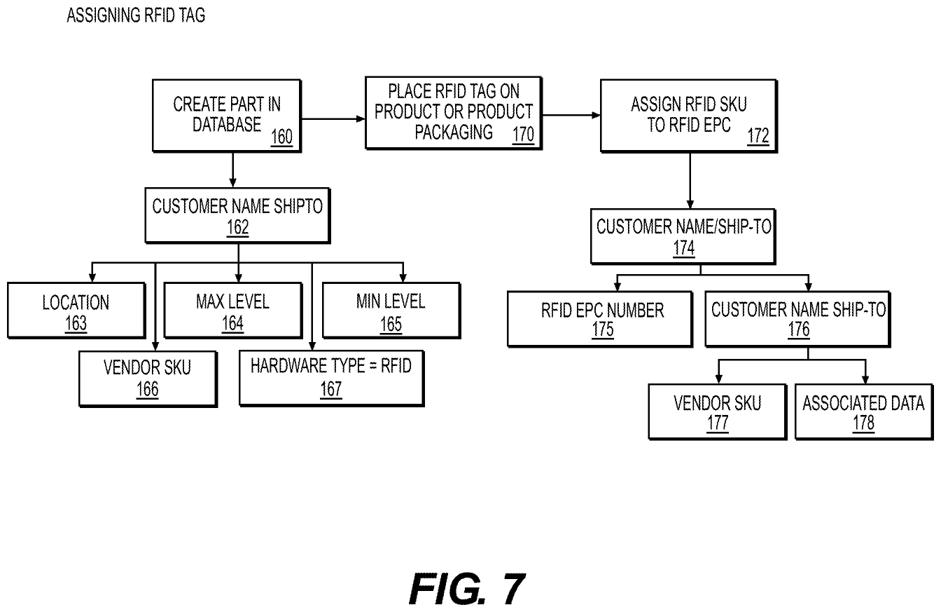

One example of how a RFID tag may be assigned to an item is further shown in FIG. 7. Item information is added to a database 160 (for example, a database of a management system), which may include the customer name for the item to be shipped to 162 and the location of the item 163. The maximum inventory level 164 and minimum inventory levels 165 may also be defined. In addition, vendor SKU number 166 and the hardware type 167 may be added to the database 160. Once the item information is added to the database 160, a RFID tag may be placed on the product or its packaging 170. The RFID tag is assigned an item identifier 172, such as an electronic product code (EPC), and the item identifier 172 is added to the database 175. The item identifier 172 may be associated with the item information entered into the database 160, including the customer name to be shipped to 176, vendor SKU 177 and other associated data 178.

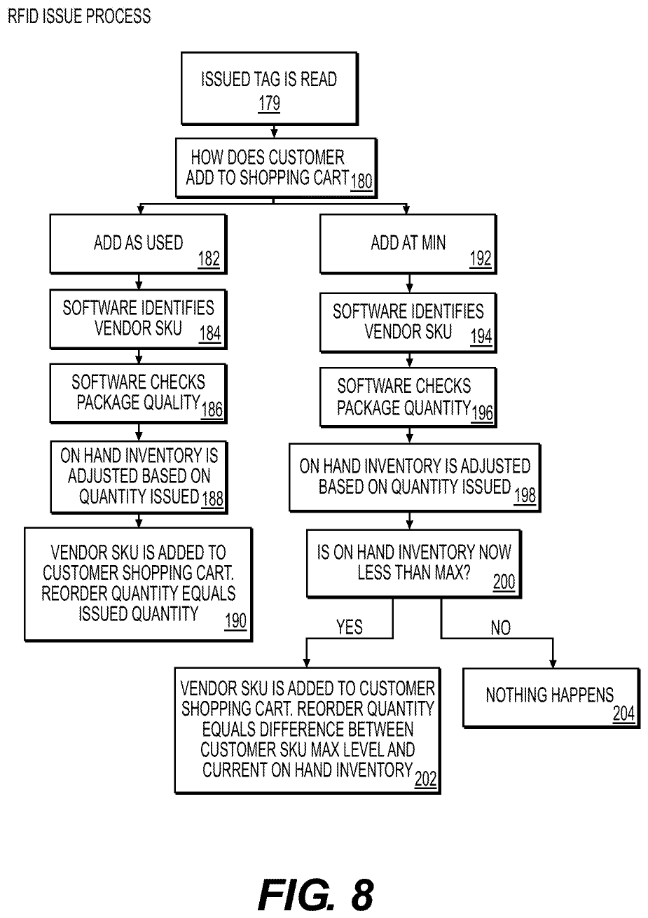

FIG. 8 is a flowchart providing an example of a RFID portal system communicating with a management system when a RFID tag is read and the status of the item is issued. When the issued item's RFID tag is read 179, the RFID storage system determines how a customer is adding the item to the shopping cart 180. If the item is added as used 182, then the management system identifies the vendor SKU 184, checks the package quantity of the item 186, and adjusts the on-hand inventory based on the quantity of items issued 188. The vendor SKU is added to the shopping cart, wherein the reorder quantity is equal to the issued quantity 190. If the item is added at a minimum quantity 192, the management system identifies the vendor SKU 194, checks the package quantity of the item 196, and adjusts the on-hand inventory based on the quantity of items issued 198. If the on-hand inventory is now less than or equal to the minimum level defined in the database, then the vendor SKU is added to the customer shopping cart, wherein the reorder quantity equals the difference between the maximum quantity and the current on-hand inventory 202. Otherwise, nothing further happens 204.

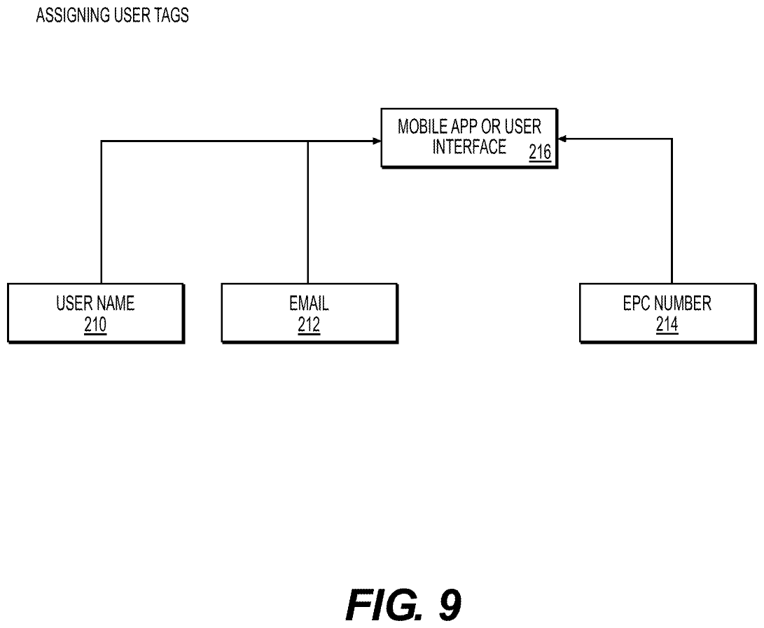

FIG. 9 is a flowchart providing one example of how a user may be setup in the RFID system. User information is added to a database 160 (for example, a database of a management system) through a mobile app or other user interface 216, which may include the customer's first name, last name 210 and email address 212. Once the user information is added to the database 160, a RFID FOB or other RFID device may be assigned to the user. The RFID FOB is assigned a user identifier 214, such as an electronic product code (EPC), and the user identifier is associated with an existing user and added to the database.

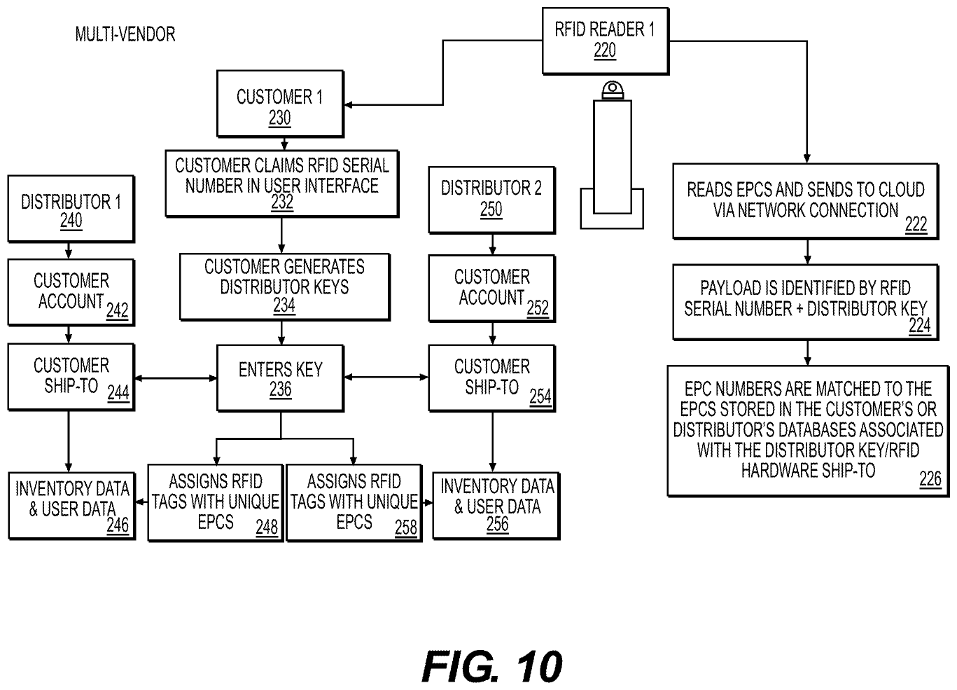

FIG. 10 provides further details on how a RFID storage system communicates with multiple vendors when a RFID tag is read and the status of the item is issued according to one embodiment. As the RFID sensor reads the RFID tag 220, the customer 230 claims the RFID serial number with the portable hub device 232. The customer generates the distributor keys 234 and gives these keys to their distributors which may be entered into a portal hub device 236. The first distributor 240 manages the customer account 242 and determines the customer ship-to 244 in their database where other data such as SKU, location and hardware type can also be associated with the customer ship-to 244. A second distributor 250 manages the customer account 252 and determines the customer ship-to 254 in their database which is independent from the first distributor's database and may contain different data pertaining to SKU, location and hardware type associated for their customer ship-to 254 for the customer. Both the first and second distributor may assign RFID tags to their item identifier for that customer and those RFID tags are also associated with the distributor key 224. When the RFID sensor reads the RFID tag 220, the item identifier is sent to a hub of the management system via the network communication system 222. The payload is identified based on the RFID serial number and a distributor key 224. The item identifier is matched to the item identifier numbers stored in the customer's or distributor's databases that are associated with the distributor key and/or RFID serial number 226.

In one embodiment, a security camera system 24 may also be included on the tower unit 14 for providing a visual signal nearby the controlled access point 6. For example, the visual signal may be a video feed or an image selected from the video feed. The image selected may be an image that provides identification of a user at the controlled access point 6. The visual signals may be stored and assigned to corresponding RFID transactions by a network camera system.

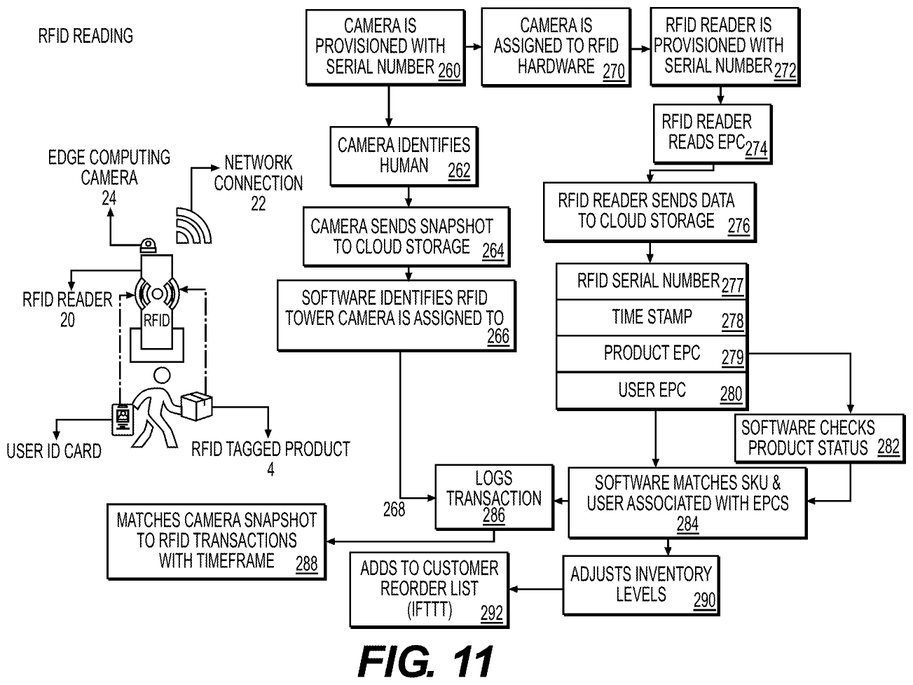

FIG. 11 provides an example of how the RFID portal system logs transactions with a security camera system. Each security camera is provisioned with a serial number 260. As a user approaches the RFID portal system, the security camera identifies the user 262. A snapshot of the user is sent to the database 264. The management system identifies the RFID portal system that the security camera is assigned to 266, and then associates the snapshot with a transaction 268. The security camera is assigned to a RFID portal system 270. The RFID sensor is provisioned with a serial number 272. When a user brings an item with a RFID tag to the tower unit, the RFID sensor reads the RFID tag to ascertain the item identifier 274, and sends data to the database 276, including RFID serial number 277, a timestamp 278, a product EPC 279 and a user EPC 280. The management system checks the product status 282 and matches the SKU and user associated data with the EPCs 204. The transaction is then logged into the database 286, and the snapshot(s) obtained by the security camera is matched to the transaction within the timeframe 288. The on-hand inventory levels within the storage unit is adjusted 290, and the item is added to the customer's reorder list 292.

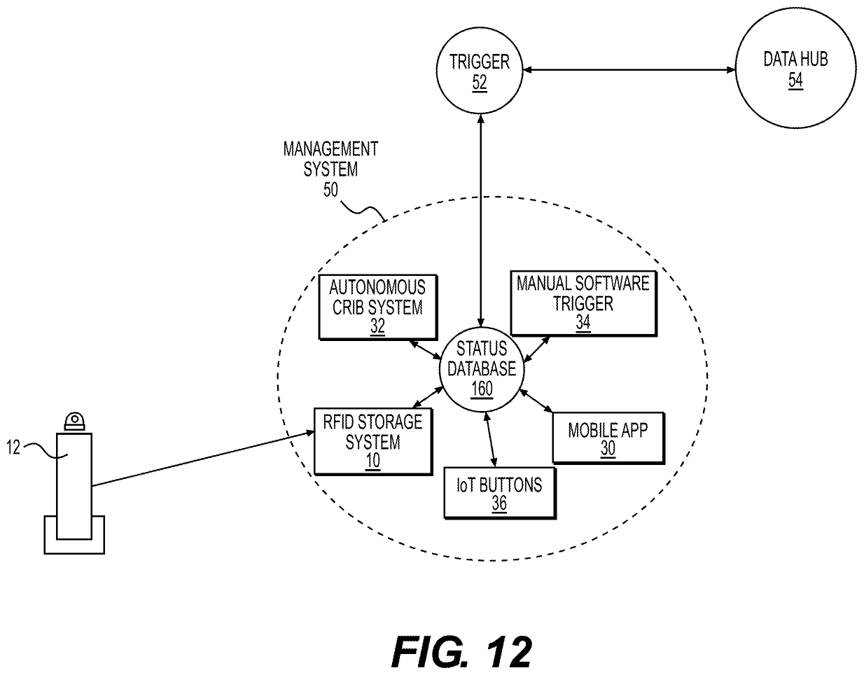

One example of a management system suitable for use with the autonomous RFID storage system 10 is disclosed in U.S. application Ser. No. 16/800,400 which is incorporated herein by reference in its entirety. The management system 50 may be adapted to manage one or more RFID storage systems 10 along with other storage systems; for example, an autonomous crib system as disclosed in U.S. application Ser. No. 16/566,270 which is incorporated herein by reference in its entirety. For example, as seen in FIG. 12, a RFID portal system 12 may be in connection with a status database wherein the status database 160 is adapted to manage the status for items stored in a plurality of storage systems. The plurality of storage systems may interface with the status database 160 through a variety of means, including an Internet-of-Things (IoT) button 36 or via sensors on an autonomous crib system 32. The status database may provide a trigger 52 to the data hub 52 for further action. The further action may include alerting the user that one or more items should be reordered, or may add the item to the customer's shopping cart with a suggested reorder quantity calculated by the dynamic on hand inventory system. In another example, the status database may trigger the item to be automatically ordered with a pre-defined reorder quantity entered by the customer.

Certain modifications and improvements will occur to those skilled in the art upon a reading of the foregoing description. By way of example, the dimensions of the individual storage units may vary depending on the size of items or the amounts of items. It should be understood that all such modifications and improvements have been deleted herein for the sake of conciseness and readability but are properly within the scope of the following claims.

We claim:

1. An autonomous RFID storage system comprising:
(a) a storage unit having a controlled access point;
(b) a RFID portal system at said controlled access point, said RFID portal system having
(i) a tower unit apart from said storage unit and positioned at a side adjacent to said controlled access point;
(ii) a RFID sensor within said tower unit adapted to read a RFID tag; and
(iii) a network connection system with said tower unit adapted to communicate with a management system.

2. The autonomous RFID storage system of claim 1 further including a RFID tag assigned to an item.

3. The autonomous RFID storage system of claim 2, wherein said RFID tag assigned to said item is associated with an item identifier for said item.

4. The autonomous RFID storage system of claim 3, wherein said item identifier is selected from one or more of an electronic product code, a stock keeping unit, a RFID serial number, a user identification, a timestamp or combinations thereof.

5. The autonomous RFID storage system of claim 3 further including a management system in communication with said network connection system adapted to manage inventory within said storage unit by storing information for each item and updating information for each item based on said item identifier received from said network connection system.

6. The autonomous RFID storage system of claim 5, wherein said management system manages inventory for a plurality of storage systems.

7. The autonomous RFID storage system of claim 5 further including a dynamic on-hand inventory system adapted to calculate an on-hand inventory quantity of an item.

8. The autonomous RFID storage system of claim 7, wherein said dynamic on-hand inventory system calculates said on-hand inventory quantity of an item on an interval based on a plurality of variables.

9. The autonomous RFID storage system of claim 8, wherein said plurality of variables is selected from one or more of an item usage history, an item stock from a vendor, a product criticality to a customer, a lead time, an average time until failure for said item, an average number of delivery days, or combinations thereof.

10. The autonomous RFID storage system of claim 5, wherein said dynamic on-hand inventory system is adapted to calculate the reorder quantity when a counter indicates a quantity of an item is below said on-hand inventory quantity.

11. The autonomous RFID storage system of claim 5, wherein said dynamic on-hand inventory system is adapted to retrieve and manage data from a plurality of vendors.

12. The autonomous RFID storage system of claim 11, wherein said dynamic on-hand inventory system is integrated with a vendor system for sending and retrieving data via an application programming interface, a file transfer protocol, an electronic data interchange, and combinations thereof.

13. A RFID portal system for an autonomous RFID storage system having a storage unit with a controlled access point, said RFID portal system comprising:
(a) a tower unit apart from said storage unit and positioned at a side adjacent to said controlled access point;
(b) a RFID sensor within said tower unit adapted to read a RFID tag;
(c) a network connection system with said tower unit adapted to communicate with a management system; and
(d) a portable hub device adapted to be carried by a user for determining whether an item is being checked in, issued or returned by assigning a status for said item.

14. The RFID portal system of claim 13 further including a user authentication system for identifying individuals accessing said storage unit at said controlled access point.

15. The RFID portal system of claim 14, wherein said user authentication system comprises a key fob system.

16. The RFID portal system of claim 15 further including a security camera system adapted to provide a visual signal and a network camera system adapted to store said visual signals obtained from said security camera system and assign said visual signals to a RFID transaction.

17. The RFID portal system of claim 13, wherein said portable hub device is a smartphone.

18. The RFID portal system of claim 13, wherein said portable hub device is adapted to assign an item identifier to a RFID tag.

19. The RFID portal system of claim 18, wherein said portable hub device assigns said status of an item to a status database.

20. The RFID portal system of claim 19, wherein said status database is adapted to compare said status of said item with said item identifier received from said network connection system.

21. The RFID portal system of claim 20, wherein said status is selected from the group consisting of an assigned status, a delivery manifest status, a check-in status, an available status, an issued status, a return manifest status, or a returned status.

22. The RFID portal system of claim 13, wherein said network connection system is a wireless network connection system in communication with a cloud storage system.

23. The RFID portal system of claim 13 further including a shielding on said tower unit adapted to prevent inadvertent reads of RFID tags by said RFID sensor.

24. An autonomous RFID storage system comprising:
(a) a storage unit having a controlled access point;
(b) a RFID tag assigned to an item and having an item identifier associated for said item;
(c) a RFID portal system at said controlled access point, said RFID portal system having
(i) a tower unit apart from said storage unit and positioned at a side adjacent to said controlled access point;
(ii) a RFID sensor within said tower unit adapted to read said RFID tag
(iii) a network connection system with said tower unit adapted to communicate with a management system;
(iv) a portable hub device adapted to be carried by a user for determining whether said item is being checked in, issued or returned by assigning a status for said item; and
(d) a management system in communication with said network connection system adapted to manage inventory within a storage unit by storing information for each item and updating information for each item based on an item identifier received from said network connection system.

25. The autonomous RFID storage system of claim 24, wherein said management system manages inventory for a plurality of storage systems.

26. The autonomous RFID storage system of claim 24 further including a dynamic on-hand inventory system adapted to calculate an on-hand inventory quantity of an item.

27. The autonomous RFID storage system of claim 26, wherein said dynamic on-hand inventory system calculates said on-hand inventory quantity of an item on an interval based on a plurality of variables.

28. The autonomous RFID storage system of claim 27, wherein said plurality of variables is selected from one or more of an item usage history, an item stock from a vendor, a product criticality to a customer, a lead time, an average time until failure for said item, an average number of delivery days, or combinations thereof.

29. The autonomous RFID storage system of claim 26, wherein said dynamic on-hand inventory system is adapted to calculate the reorder quantity when a counter indicates a quantity of an item is below said on-hand inventory quantity.

30. The autonomous RFID storage system of claim 26, wherein said dynamic on-hand inventory system is adapted to retrieve and manage data from a plurality of vendors.

31. The autonomous RFID storage system of claim 30, wherein said dynamic on-hand inventory system is integrated with a vendor system for sending and retrieving data via an application programming interface, a file transfer protocol, an electronic data interchange, and combinations thereof.

32. The autonomous RFID storage system of claim 24 further including a user authentication system for identifying individuals accessing said storage unit at said controlled access point.

33. The autonomous RFID storage system of claim 24 further including a security camera system adapted to provide a visual signal and a network camera system adapted to store said visual signals obtained from said security camera system and assign said visual signals to a RFID transaction.

34. The autonomous RFID storage system of claim 24, wherein said portable hub device is a smartphone.

35. The autonomous RFID storage system of claim 24, wherein said portable hub device is adapted to assign an item identifier to a RFID tag.

36. The autonomous RFID storage system of claim 35, wherein said portable hub device assigns said status of an item to a status database.

37. The autonomous RFID storage system of claim 36, wherein said status database is adapted to compare said status of said item with said item identifier received from said network connection system.

38. The autonomous RFID storage system of claim 36, wherein said status is selected from the group consisting of an assigned status, a delivery manifest status, a check-in status, an available status, an issued status, a return manifest status, or a returned status.

39. The autonomous RFID storage system of claim 24, wherein said network connection system is a wireless network connection system in communication with a cloud storage system.

40. The autonomous RFID storage system of claim 24 further including a shielding on said tower unit adapted to prevent inadvertent reads of RFID tags by said RFID sensor.
